(19) United States
(12) Patent Application Publication
(10) Pub. No.: US 2021/0072068 A1
(43) Pub. Date: Mar. 11, 2021

(54) MULTI-RANGE FLOWMETER

(71) Applicants: OR TRAUBE, (US); ALON ASHKENAZI, (US); SHERLOCK LEAKS & FLOODS LTD, Herzelia (IL)

(72) Inventors: OR TRAUBE, HERZELIA (IL); ALON ASHKENAZI, GIVAT SHMUEL (IL)

(21) Appl. No.: 17/015,727

(22) Filed: Sep. 9, 2020

(30) Foreign Application Priority Data
Sep. 9, 2019 (IL) 269235

(51) Int. Cl. G01F 15/06; G05D 7/06; G08C 25/02

(52) U.S. Cl. CPC G01F 15/063; G01F 15/005; G08C 25/02; G05D 7/0623

(57) ABSTRACT

A multi range flowmeter, connected inline a fluid supply line for flow measurement, comprises at least one low range flow sensor for measuring a branch-flow of fluid passing in a branch that branches off a trunk; a flow driven valve configured to pass fluid from the trunk when a trunk-flow in the trunk exceeds a preset flow level; and a high range flow sensor for measuring the branch-flow and the trunk-flow, wherein the flow measurement is the measurement of the branch-flow when the trunk-flow is below the preset flow level, and wherein the flow measurement is the measurement of the branch-flow and the trunk-flow when the trunk-flow is above the preset flow level.

### CROSS-REFERENCE TO RELATED APPLICATION

This patent application is based upon and claims the priority of co-pending Israeli Patent Application No. 269235, filed Sep. 9, 2019, which is incorporated herein by reference in its entirety.

### TECHNICAL FIELD

The present disclosed subject matter relates to fluid mechanics. More particularly, the present disclosed subject matter relates to multi-range flowmeters.

### BACKGROUND OF THE INVENTION

Flowmeters are instrument capable of measuring the amount of fluid passing through a pipe per given time. Commercially available flowmeters vary depending on the measurement applications; budgetary terms; maintenance requirements; but primarily on the flow range, which corresponds with a cross-section diameter of the fluid conducting pipe.

Gas and liquid flow can be measured in volumetric or mass flow rates, such as liters per second or kilograms per second, respectively. For liquids, various units are used depending upon the application and industry, but might include gallons (U.S. or imperial) per minute, liters per second or per minute or, cubic meters per hour and the like.

Regardless of the type of technology utilized for flow measurement, namely quantifying of bulk fluid movement per given time, maintaining high resolution measurement across large dynamic range is a challenge that is one of the objectives of the present disclosure.

BRIEF SUMMARY OF THE INVENTION

It is provided in accordance with a preferred embodiment of the present disclosure a multi range flowmeter, connected inline a fluid supply line for flow measurement, the flowmeter comprising:

at least one low range flow sensor for measuring a branch-flow of fluid passing in a branch that branches off a trunk;

a flow driven valve configured to pass fluid from the trunk when a trunk-flow in the trunk exceeds a preset flow level; and a high range flow sensor for measuring the branch-flow and the trunk-flow, wherein the flow measurement is the measurement of the branch-flow when the trunk-flow is below said preset flow level, and wherein the flow measurement is the measurement of the branch-flow and the trunk-flow when the trunk-flow is above said preset flow level.

According with another preferred embodiment of the present disclosure, the flowmeter further comprises actuated main valve configured to open and close the fluid supply line.

According with another preferred embodiment of the present disclosure, the flowmeter further comprises front-end electronics (FEE) configured acquire and process signals from the at least one low range flow sensor and the high range flow sensor.

According with another preferred embodiment of the present disclosure, the flowmeter further comprises a transceiver configured to transmits signals and receive instructions.

According with another preferred embodiment of the present disclosure, the FEE is instructed via the transceiver to open or close the fluid supply line with the actuated main valve.

It is provided in accordance with yet another preferred embodiment of the present disclosure a monitoring system comprising:
at least one flowmeter as disclosed herein before;
a transceiver configured to communicate with the transceiver the at least one flowmeter;
a communication unit configured to provide indications and measurements information to at least one user's interface; and
a controller configured to process signals obtained by the transceiver for determining indication and measurements information of the at least one flowmeter, wherein the controller also communicates instructions to the at least one flowmeter via the transceiver.

According with another preferred embodiment of the present disclosure, the controller is configured to obtain predetermine time and predetermine quantity values from the at least one user's interface via the communication unit, and wherein the controller said communicates instructions to the at least one flowmeter via the transceiver to close the actuated main valve upon exceeding either the predetermine time or the predetermine quantity.

Unless otherwise defined, all technical and scientific terms used herein have the same meaning as commonly understood by one of ordinary skill in the art to which this disclosed subject matter belongs. Although methods and materials similar or equivalent to those described herein can be used in the practice or testing of the present disclosed subject matter, suitable methods and materials are described below. In case of conflict, the specification, including definitions, will control. In addition, the materials, methods, and examples are illustrative only and not intended to be limiting.

### BRIEF DESCRIPTION OF THE DRAWINGS

Some embodiments of the disclosed subject matter described, by way of example only, with reference to the accompanying drawings. With specific reference now to the drawings in detail, it is stressed that the particulars shown are by way of example and for purposes of illustrative discussion of the preferred embodiments of the present disclosed subject matter only, and are presented in the cause of providing what is believed to be the most useful and readily understood description of the principles and conceptual aspects of the disclosed subject matter. In this regard, no attempt is made to show structural details of the disclosed subject matter in more detail than is necessary for a fundamental understanding of the disclosed subject matter, the description taken with the drawings making apparent to those skilled in the art how the several forms of the disclosed subject matter can be embodied in practice.

In the drawings:

FIG. 1 illustrates a functional block diagram of a multi-range flowmeter, in accordance with some exemplary embodiments of the disclosed subject matter; and

FIG. 2 illustrates a functional block diagram of a flood detection system, in accordance with some exemplary embodiments of the disclosed subject matter.

### DETAILED DESCRIPTION OF THE INVENTION

Before explaining at least one embodiment of the disclosed subject matter in detail, it is to be understood that the disclosed subject matter is not limited in its application to the details of construction and the arrangement of the components set forth in the following description or illustrated in the drawings. The disclosed subject matter is capable of other embodiments or of being practiced or carried out in various ways. Also, it is to be understood that the phraseology and terminology employed herein is for the purpose of description and should not be regarded as limiting. The drawings are generally not to scale. For clarity, non-essential elements were omitted from some of the drawings.

The terms “comprises”, “comprising”, “includes”, “including”, and “having” together with their conjugates mean “including but not limited to”. The term “consisting of” has the same meaning as “including and limited to”.

The term “consisting essentially of” means that the composition, method or structure can include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” can include a plurality of compounds, including mixtures thereof.

Throughout this application, various embodiments of this disclosed subject matter can be presented in a range format. It should be understood that the description in range format is merely for convenience and brevity and should not be construed as an inflexible limitation on the scope of the disclosed subject matter. Accordingly, the description of a range should be considered to have specifically disclosed all the possible sub-ranges as well as individual numerical values within that range.

It is appreciated that certain features of the disclosed subject matter, which are, for clarity, described in the context of separate embodiments, can also be provided in combination in a single embodiment. Conversely, various features of the disclosed subject matter, which are, for brevity, described in the context of a single embodiment, can also be provided separately or in any suitable sub-combination or as suitable in any other described embodiment of the disclosed subject matter. Certain features described in the context of various embodiments are not to be considered essential features of those embodiments, unless the embodiment is inoperative without those elements.

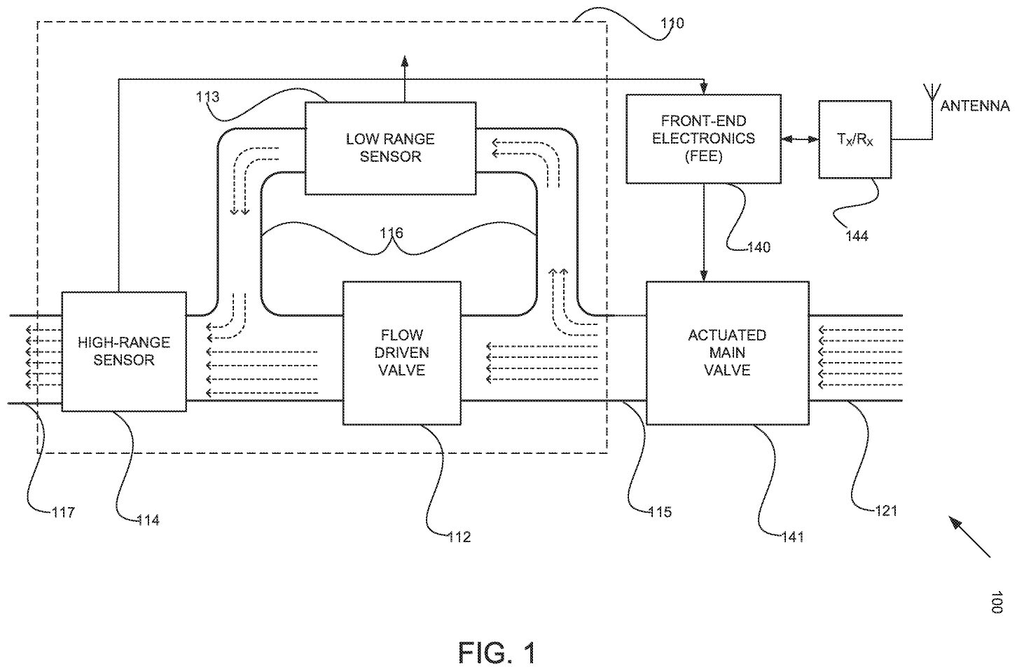

Referring now to FIG. 1 illustrating a functional block diagram of a multi-range flowmeter 100, in accordance with some exemplary embodiments of the disclosed subject matter. The multi-range flowmeter 100 comprises at least one multi-range flow-sensors 110, front end electronics (FEE) 140, a transceiver (TxRx) 144 and an actuated main valve 141.

Fluid, such as water, can ingress the multi-range flow-sensors via inlet trunk 115 where it is split to a low-range flow sensor 113, via a first branch 116, and a flow driven valve 112. In some exemplary embodiments, the flow driven valve 112 is open, i.e. allowing fluid to pass through if the flow at the inlet trunk 115 is above a preset flow level, for example 1 liters per minute [lpm]. Alternatively, if the flow at the inlet trunk 115 is below a preset flow level, for example 1[lpm], valve 112 will be closed, which means that the fluid will flow only via branch 116.

Regardless of a the state (open or close) of the flow driven valve 112, fluid flows from branch 116 through low-range sensor 113 will mix with fluid coming from valve 112 (if open) to egress the multi-range flow-sensors 110 through high range flow sensor 114. In some exemplary embodiments, ingress 115, inlet to valve 112, outlet of valve 112, inlet to high-range sensor 114 and egress 117 as well as piping (tubing) interconnecting between them are all having about the same diameter, hereinafter high flow path or just high path. In contrast, branches 116 as well as inlet and outlet of sensor 113 have a diameter that is substantially smaller than the diameter of the high flow path. For example, the diameter of the high flow path can be in the range of 0.75″ to 2.5″, whereas the first branches 116 are typically 0.5″.

In some exemplary embodiments of the disclosed subject matter, multi-range flowmeter 110 can comprise additional branches (not shown), such as branches 116, in order to further expanding the resolution of the dynamic range.

In some exemplary embodiments, low-range sensor 113 comprises at least one sensor configured to sense liquid flow-rates that range from approximately 0.05[lpm] up to approximately 1.5[lpm]. On the other hand, high-range sensor 114 comprises at least one sensor configured to sense liquid flow-rates that range from approximately 1[lpm] up to approximately 50[lpm]. Both sensors, 113 and 114, can use a commercially available technology capable of providing an electrical value outcome that is proportional to the flow.

In some exemplary embodiments, when the flow at the ingress 115 falls below the preset flow level, for example, below 1[1pm], valve 112 closes, thereby all the fluid passes only via branches 116 to enter sensor 114 and exits from egress 117. In contrast, when the flow at ingress 115 exceeds the preset flow level, for example 1[1pm] or above, valve 112 opens, thereby allowing a majority of the fluid to pass via valve 112 and mix with flow coming from branches 116 to enter together to sensor 114.

It will be understood that valve 112 operates as shunt that practically toggles the multi-range flow-sensors 110 from low range to high range, thereby expanding the dynamic range of the present disclosure. In some exemplary embodiments, the preset flow level (shunt) value is derived/dictated by ranges of the available sensors 113 and 114.

As an example, for multi-range flowmeter 100 configured to measure flow rates varying from 0.15 lpm to 30 lpm, the following components can be used:
i) a low-range sensor 113 calibrated for a range of 0.05 [lpm] to 2[lpm]
ii) a high-range sensor 114 calibrated for a range of 1[lpm] to 40[lpm]
iii) a flow driven valve 112 (shunt) calibrated switch from close to open at above 1.5[1pm] and vice versa at below 1.5[lpm].

In the configuration of the above example, the multi-range flowmeter 100 utilizes measurements obtained from sensor 113 as long as the flow is below 1.5[lpm] and the measurements obtained from sensor 114 as long as the flow is above 1.5[lpm].

In some exemplary embodiments of the disclosed subject matter, multi-range flowmeter 100 comprises a front-end electronics (FEE) 140. FEE 140 can be used to acquire measurements readings from sensors 113 and 114 and convert the readings to either digital or analog information. FEE 140 can be an electronic circuit comprising a plurality of IC, such as analog-to-digital converter (ADC), noise filters, amplifiers, a combination thereof, or the like. In addition, FEE 140 can open or close an actuated main valve 141, which is connected between a main (fluid) supply 121 and ingress 115, thereby enables/disables fluid supply to a facility connected to egress 117.

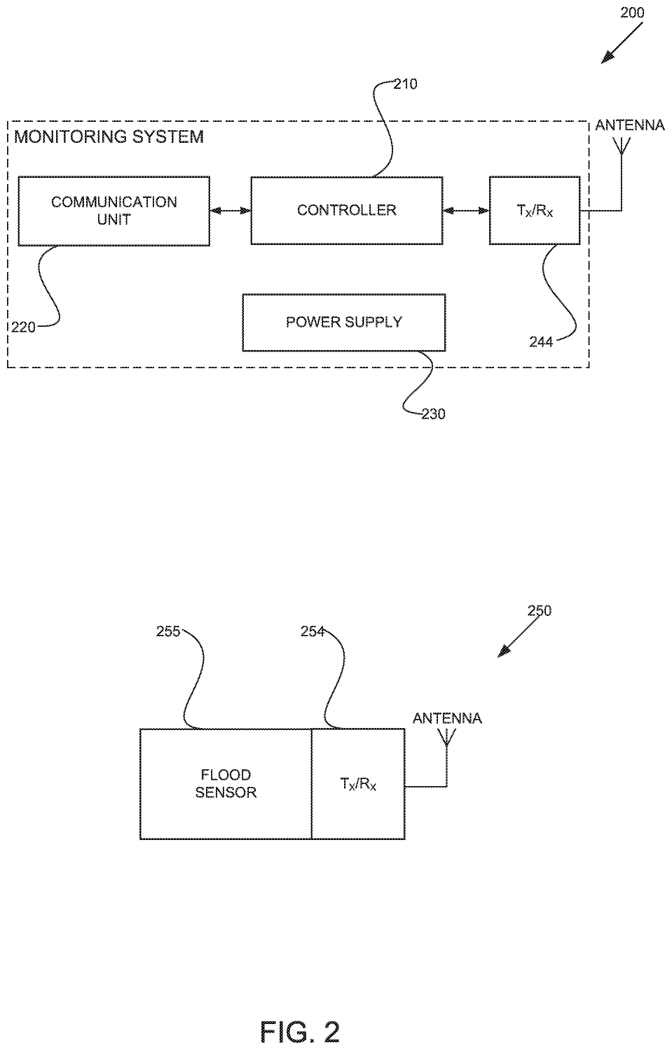

Additionally, or alternatively, the FEE 140 can be configured to communicate via transceiver (TxRx) 144 with a controller of FIG. 2 (to be described in detail further below). The TxRx 144 can be a radio transmitter/receiver configured transmit data, e.g. measurements readings and receive instructions, such as opening and closing valve 141. TxRx 144 can be a two-way radio that uses an antenna and configured to operate at 433 MHz or the like.

Referring now to FIG. 2 illustrating a functional block diagram of a monitoring system 200 and flood detection device 250, in accordance with some exemplary embodiments of the disclosed subject matter. Monitoring system 200 can be a computerized system adapted to acquire and process measurement information from at least one multi-range flowmeter 100 and other devices, such as for example flood detection device 250. Additionally, system 200 is used to provide users of the system with results and information, in addition to obtaining instructions from the user.

In some exemplary embodiments, the monitoring system 200 can comprise a controller 210, a communication unit 220, a transceiver (TxRx) 244, and a power-supply 230 that have a battery backup. The controller 210 can be a central processing unit (CPU), a microprocessor, a field-programmable gate array (FPGA), an application-specific integrated circuit (ASIC), an electronic circuit comprising a plurality of integrated circuits (IC), a combination thereof, or the like.

In some exemplary embodiments, controller 210 can comprise a memory unit (not shown). The memory unit can be a flash disk, a random-access memory (RAM), a memory chip, a flash memory, a combination thereof, or the like. In some exemplary embodiments, the memory unit is used to retain software elements, data elements, any combination thereof, or the like. The software elements can comprise algorithms, programs, instructions, functions, and files that are operative to cause controller 210 to perform executions associated with monitoring system 200 and its subcomponents. In some exemplary embodiments, the memory unit can retain sensors raw data and outcomes of flood detection system 200.

In some exemplary embodiments, communication unit 220 can be used to provide an interface to a user of the system, such as by providing output, visualized measurements results, reports, as well as inputting instructions to the system. The user can use computerized equipment (not shown); such as a handheld computer, a laptop computer, a smartphone, or the like; that is used as a user's interface to system 200. It will be appreciated that monitoring system 200 can operate for continues monitoring without user's intervention.

In some exemplary embodiments, unit 220 can utilize one or more communication technologies, such as Wi-Fi, Bluetooth and wired LAN, for interfacing with the user's computerized equipment (not shown). Additionally, or alternatively, unit 220 may comprise a subscriber identity module (SIM) to enable wireless data communication using protocols, such as general packet radio service (GPRS); enhanced data rates for global evolution (EDGE), or the like.

In some exemplary embodiments, the TxRx 244 can be used by controller 210 to communicate with at least one multi-range flowmeter 100 and at least one device 250. TxRx 244 can be a radio transmitter/receiver configured to communicate instructions and data, such as measurements readings, instructions, and indications. In some exemplary embodiments, TxRx 244 can be a two-way radio that uses an antenna and configured to operate at 433 MHz or the like.

In one exemplary embodiments of the disclosed subject matter, multi-range flowmeter 100 coupled with monitoring system 200 is used as a measurement equipment for monitoring flow of fluids in industrial and/or commercial applications. In such application an outcome of flow measurement reading can be displayed on a supplement computerized equipment and or used to control equipment and machinery that use the measured fluid.

In another exemplary embodiments of the disclosed subject matter, system 200 and at least one flow meter 100 can be used as a leakage prevention system, particularly for leaks where the fluid doesn't end on the ground (not a flood). Such leaks are characterized in that the liquid flows directly to any drain or a vessel. In such embodiment, the flowmeter 100 and system 200 of the present disclosure can minimize leaks damages by restricting the fluid flow to a predetermined time or predetermined quantity.

In such embodiments, system 200 utilizes flow meter 100 to determine a flow state and a nonflow state, in the nonflow state (contrast to the flow state) both readings of sensors 113 and 114 are zero, thus a change from nonflow to flow state indicates a flow start event. In some exemplary embodiments, upon determining flow start event, system 200 triggers a timer configured to shut down the actuated main valve 141 upon exceeding the predetermined time. Additionally, or alternatively, upon determining flow start event, system 200 starts calculating an accumulated flow of fluid (quantity) and shut down the actuated main valve 141 upon exceeding the predetermined quantity. It should be noted that, that both the predetermined time as well as the predetermined quantity can be preset by the user, for example 30 minutes and 50 liters respectively. It should also be noted that, in addition to shutting down the actuated main valve 141, system 200 reports a shutdown event to the user by utilizing any of the methods available to communication unit 220.

In some exemplary embodiments of the disclosed subject matter, system 200 further comprises a flood detection device 250. Device 250 can be comprised of a commercially available flood sensor 255 and a transceiver (TxRx) 254. TxRx 254 can be similar to TxRx 244 and may be used for communication with monitoring system 200. Flood sensor 255 is designed to detect presence of water in places where water is unexpected, and provide an indication of such presence. Flood sensor 255 is based on the electrical conductivity of water to decrease the resistance across two contacts. Upon such resistance drop TxRx 254 communicates a flood indication signal to system 200. In some exemplary embodiments, device 250 can be operated by disposable battery, however it will be noted that, the TxRx 254 of device 250 may be in sleep mode until a flood is detected.

In yet another exemplary embodiment, the described above leakage prevention system can be provided with at least one flood detection device 250 in addition to the system 200 and at least one flow meter 100. By integrating the at least one device 250 the provided system is enhanced with flood detection capabilities in addition to the, listed above, leakage prevention capabilities. Additionally, or alternatively, upon flood detection, by the at least one device 250, controller 210 of system 200 can shut down the actuated main valve 141 in addition to reporting a flood detection to the user.

The present disclosed subject matter can be a system, a method, and/or a computer program product. The computer program product can include a computer readable storage medium (or media) having computer readable program instructions thereon for causing a processor to carry out aspects of the present disclosed subject matter.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosed subject matter can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosed subject matter.

Aspects of the present disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosed subject matter. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

1. A multi range flowmeter, connected inline a fluid supply line for flow measurement, the multi range flowmeter comprising:
at least one low range flow sensor for measuring a branch-flow of fluid passing in a branch that branches off a trunk;
a flow driven valve configured to pass fluid from the trunk when a trunk-flow in the trunk exceeds a preset flow level; and
a high range flow sensor for measuring the branch-flow and the trunk-flow, wherein the flow measurement is the measurement of the branch-flow when the trunk-flow is below said preset flow level, and wherein the flow measurement is the measurement of the branch-flow and the trunk-flow when the trunk-flow is above said preset flow level.

2. The multi range flowmeter of claim 1, further comprising an actuated main valve configured to open and close the fluid supply line.

3. The multi range flowmeter of claim 1, further comprising front-end electronics (FEE) configured acquire and process signals from the at least one low range flow sensor and the high range flow sensor.

4. The multi range flowmeter of claim 3, further comprising a flowmeter transceiver configured to transmit signals and receive instructions.

5. The flowmeter of claim 4, wherein the FEE is instructed via the flowmeter transceiver to open or close the fluid supply line with the actuated main valve.

6. A monitoring system comprising:
at least one multi range flowmeter of claim 5;
a monitoring transceiver configured to communicate with the flowmeter transceiver of the at least one multi range flowmeter;
a communication unit configured to provide indications and measurements information to at least one user's interface; and
a controller configured to process signals obtained by the monitoring transceiver for determining the indications and measurements information of the at least one flowmeter, wherein the controller also communicates instructions to the at least one flowmeter via the monitoring transceiver.

7. The monitoring system of claim 6, wherein the controller is configured to obtain predetermined time values and predetermined quantity values from the at least one user's interface via the communication unit, and wherein the controller communicates instructions to the at least one multi range flowmeter via the monitoring transceiver to close the actuated main valve upon exceeding either the predetermined time values or the predetermined quantity values.

8. The monitoring system of claim 6, wherein the system further comprises at least one flood detection device comprising a flood sensor; a device transceiver; and an autonomous power supply, wherein the flood detection device is configured to detect flood in a vicinity of the at least one multi range flowmeter.

9. The monitoring system of claim 7, wherein the monitoring transceiver is further configured to communicate with the device transceiver of the flood detection device, wherein flood indication communication from the flood detection device to the monitoring system cause the controller to shut down the actuated main valve and report a flood detection to the user.
